(19) United States
(12) Patent Application Publication
(10) Pub. No.: US 2025/0198217 A1
(43) Pub. Date: Jun. 19, 2025

(54) ADJUSTMENT DEVICE FOR A FUNCTIONALIZED WINDOW PANE

(71) Applicant: Brose Fahrzeugteile SE & Co. Kommanditgesellschaft, Bamberg, Bamberg (DE)

(72) Inventors: Andre CARL, Ebersdorf (DE); Mark WAGNER, Breitenguessbach (DE); Thorsten KUHNEN, Litzendorf (DE)

(73) Assignee: Brose Fahrzeugteile SE & Co. Kommanditgesellschaft, Bamberg, Bamberg (DE)

(21) Appl. No.: 19/062,598

(22) Filed: Feb. 25, 2025

Related U.S. Application Data
(63) Continuation of application No. PCT/EP2023/072545, filed on Aug. 16, 2023.

(30) Foreign Application Priority Data
Aug. 26, 2022 (DE) 10 2022 208 865.4

(51) Int. Cl. E05F 15/689

(52) U.S. Cl. CPC E05F 15/6909; E05Y 2201/684; E05Y 2400/654; E05Y 2900/55

(57) ABSTRACT

An adjustment device for a motor vehicle, comprising a window lifter for adjusting a functionalized window pane, and a guide system for a cable which is connected to the functionalized window pane and serves to conduct current to and/or to control the window pane. The guide system has a flexible component, which receives the cable, and a sliding element, which is coupled to the window pane and is guided on a rail-like guide element separated from the window lifter.

This nonprovisional application is a continuation of International Application No. PCT/EP2023/072545, which was filed on Aug. 16, 2023, and which claims priority to German Patent Application No. 10 2022 208 865.4, which was filed in Germany on Aug. 26, 2022, and which are both herein incorporated by reference.

### BACKGROUND OF THE INVENTION

### Field of the Invention

The invention relates to an adjustment device for a functionalized window pane, in particular for a moving or movable side window, of a motor vehicle.

### Description of the Background Art

An adjustment device can be understood to be, for example, components or parts of a window lifter, in particular an electromotive one, preferably a cable window lifter, for a functionalized window pane, for example for a side window in a vehicle door.

In particular, a functional window pane can be understood to be an electrically switchable or controllable (motor vehicle) glazing, i.e., a window pane with an electrically switchable or controllable functional layer, in particular an electro-transparent, an antenna-functional, a heatable or a luminous layer. In other words, a functional layer of the window pane, in particular optical and/or thermal, is provided, the functions of which can be influenced, changed, switched, or controlled by means of electrical control signals. A functionalized window pane is also understood to be tinting glazing in the manner of electroactive or electrochromic glass (smart glass).

To control such functionalized window panes, they must be coupled to a power source and/or a control device (controller) as electronics in order to be able to transmit control signals. In particular, in the case of movable or adjustable windows of a motor vehicle, such as a side window, the signal transmission link between the window pane and the electronics is associated with a high level of design and installation effort.

In addition, the routing of conductors or a cable with such conductors in order to conduct current to and/or transmit signals to the functionalized window pane, is done, for example, with a lever arrangement, typically by directly connecting the cable and/or a plug contact connected to it to a driver coupled to the vehicle window or a rail slider of the single-strand or two-strand window lifter. This makes the cable or conductor guidance dependent on the positioning and respective design or configuration of the components of the window lifter, which is often undesirable in view of limited flexibility and the need for coordination with the window lifter components.

### SUMMARY OF THE INVENTION

It is therefore an object of the invention to provide a particularly suitable adjustment device for a functionalized window pane of a motor vehicle. In particular, the guidance of conductors or a cable with such conductors for power and/or signal supply to the functionalized window pane, for example with regard to suitable positioning, should be as independent as possible of the window lifter or its components. Furthermore, a guide system should be specified which is particularly suitable for guiding such conductors or cables to a functionalized window pane, in particular to a side window, of a motor vehicle and is as independent as possible of the window lifter or its components.

The advantages and designs listed with regard to the assembly can also be applied to the guide system by analogy, and vice versa.

The adjustment device has a window lifter for adjusting a functionalized window pane along an adjustment travel, and a guide system for a cable, which is or can be connected to the functionalized window pane to conduct current to and/or to control the functionalized window pane. The guide system has a flexible component that receives the cable, and a sliding element which is coupled to the window pane and is guided along the adjustment travel by a rail-like guide element, which is separated from the window lifter. Conveniently, the flexible component is attached to the sliding element of the guide system on the one hand and fixedly to a body part of the motor vehicle, in particular on a door module or on a door shell, on the other.

The window lifter suitably has at least one guide rail with a driver for the window pane guided on it in a sliding motion, as well as an adjustable drive, in particular an electromotive drive, which is connected (coupled) to the driver via a traction cable. The window lifter can be single-strand with a single guide rail or double-strand with two parallel guide rails. The rail-like guide element for the sliding element of the guide system is arranged parallel to the guide rail or each guide rail and arranged separately from the window lifter. The rail-like guide element of the guide system is thus an element (component) that is added to the guide rail or to each guide rail in the manner of, preferably also, a guide rail, which is provided or configured for the sliding element.

The sliding element of the guide system is preferably exclusively coupled to the window lifter via the window pane. In other words, the components of the window lifter, in particular the driver or each driver, and the traction cable coupled to this and to the adjustable drive, are at best indirectly coupled to the guide system via the window pane and in particular to the separately guided sliding element. Without a window pane, there is therefore no connection of the guide system to the window lifter or its components. This provides more freedom or possibilities for positioning the guide system, in particular in a door body or door shell of a vehicle door. The components of the window lifter and those of the guide system can thus be determined and/or configured independently of each other.

In a suitable design, the flexible component is effective in the manner of a drag chain and is designed, for example, as a flexible tube (hollow tube). It is particularly advantageous if the flexible component, which is made of a plastic material in particular, is designed and/or effective as a corrugated pipe. The flexible component preferably encloses the cable at least substantially completely. The flexible component is conveniently guided on and/or under the rail-like guide element of the guide system. For this purpose, the rail-like guide element of the guide system advantageously has a guide area for the component running in the longitudinal direction of the rail. Suitably, the rail-like guide element is designed with a (longitudinal) groove or channel running in its longitudinal direction.

As a result of a particularly advantageous further development, the sliding element of the guide system is or can be coupled to the functionalized window pane or to a pane adapter connected to it by means of a flexible connecting element. The flexible connecting element is suitably hinged to the window pane or to the pane adapter and/or to the sliding element. For this purpose, for example, a hinge-like connection may be established between the sliding element, which is movably guided on the rail-like guide element, and a pane adapter provided in addition to the pane adapter associated with the window lifter.

The guide system for a cable, which is or can be connected to the functionalized window pane and which serves to conduct current to and/or to control the functionalized window pane, has a flexible component that receives the cable and a sliding element that is coupled to the functionalized window pane, preferably via a flexible connecting element, which is guided on a rail-like guide element and is connected to the flexible component. The guide system can be assembled and, in particular, freely positioned independently of a window lifter or its components, preferably in a body shell of a motor vehicle door (door shell, door frame).

Only when the functionalized window pane or side window of the vehicle is mounted and coupled to the window lifter is a coupling also established with the guide system. The sliding element of the guide system is only moved synchronously with the driver or each of the drivers of the window lifter when the coupling is connected via the functionalized window pane or side window. In this case, the cable routed in the flexible component is guided via the adjustment travel or adjustable stroke free of collision and damage from the door shell or from electronics arranged on the door shell to the window pane or side window.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limited of the present invention, and wherein:

FIG. 1 shows an adjustment device for a functionalized window pane of a motor vehicle, comprising a two-strand (cable) window lifter and a guide system for a cable, which is received in a (corrugated) tube to conduct current to and/or control the functionalized window pane;

FIG. 2 shows a section of FIG. 1 in perspective representation with the guide element, which is separated from the respective guide rail of the window lifter, with a sliding element guided thereon for holding the (corrugated) pipe or cable; and

FIGS. 3 and 4 show a section of FIG. 2 in different perspective representations with a view to a flexible or articulated connection of the sliding element, with a (corrugated) pipe coupled to it, with a pane adapter having an (electrical) connection area for a cable-side plug contact.

### DETAILED DESCRIPTION

In the following, information relating to spatial directions is provided, in particular in a coordinate system of the motor vehicle (vehicle coordinate system), in relation to an exemplary installation situation of a window lifter in a side door of the motor vehicle. The abscissa axis (X-axis, X-direction) is oriented along the longitudinal direction of the vehicle (direction of travel), the ordinate axis (Y-axis, Y-direction) along the transverse direction of the vehicle, and the applicate axis (Z-axis, Z-direction) along the height of the vehicle.

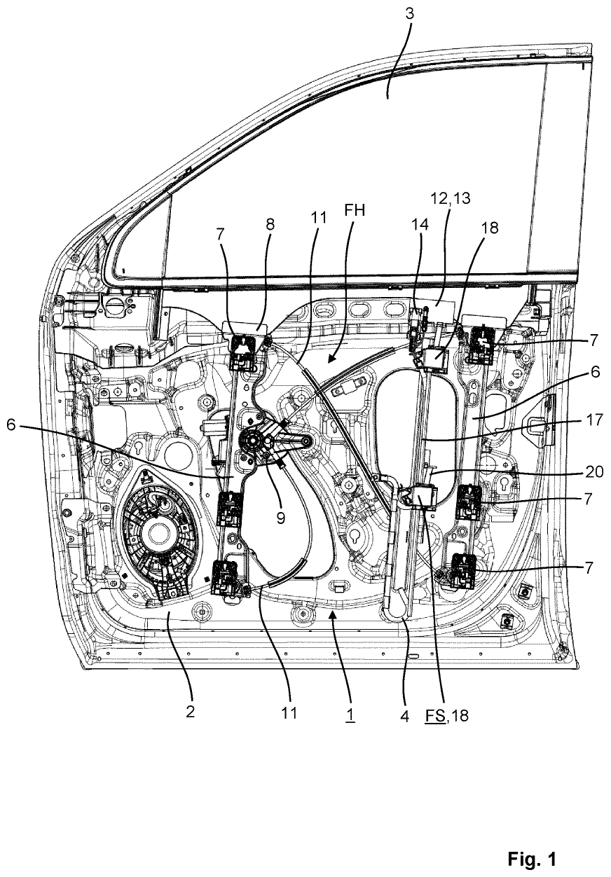

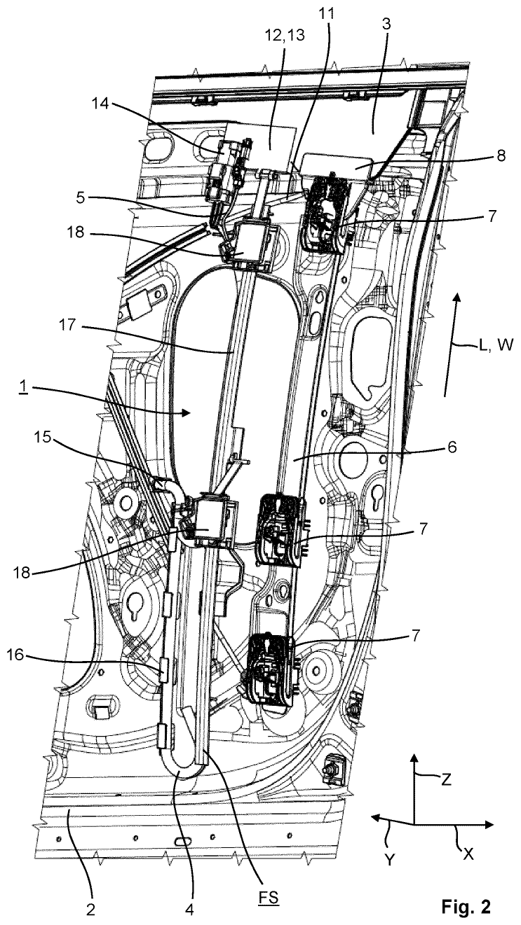

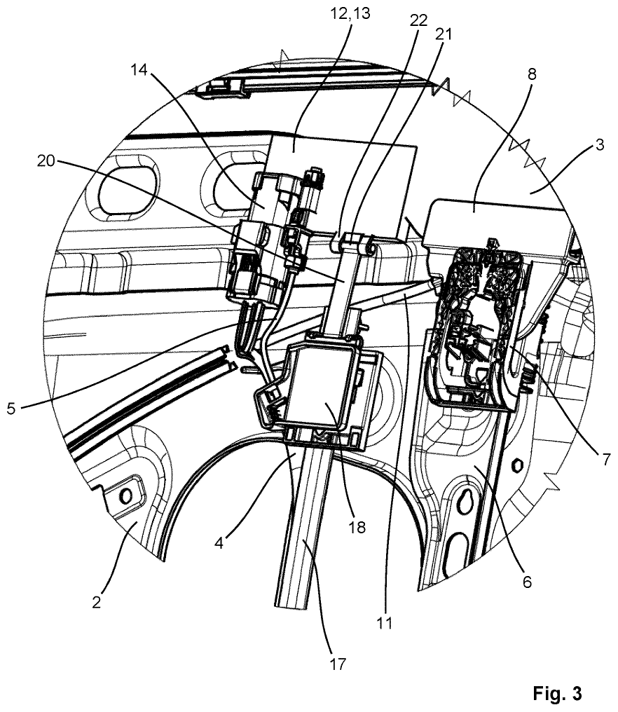

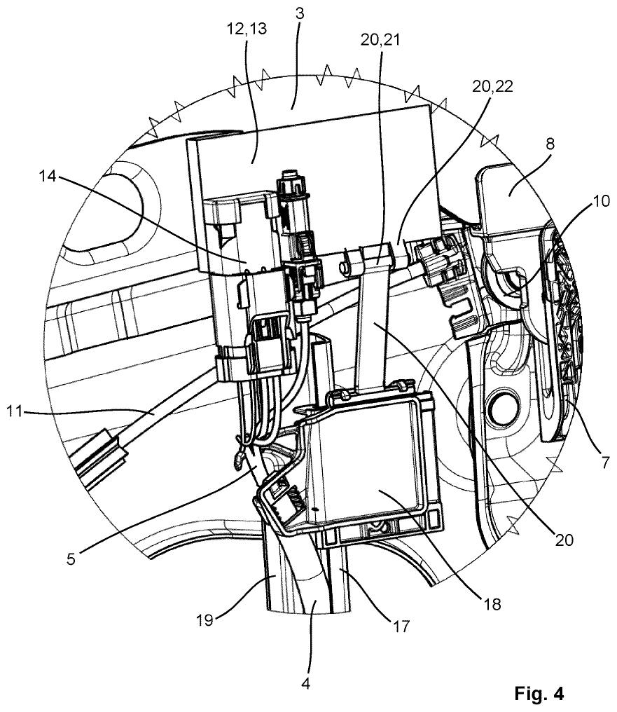

FIGS. 1 and 2 show an adjustment device and an assembly 1, respectively, as a component of an adjustment device in a side door of a motor vehicle. Specifically, FIG. 1 shows a door shell or door frame 2 without any door outer panel (outer sheet metal) and without any door interior lining. In or on the door shell or door frame 2 in the example, a two-strand window lifter assembly, hereinafter referred to as a window lifter FH, for a functionalized window pane (side window) 3 and a guide system FS for a flexible component 4 is mounted, in which a cable 5 routed to the window pane 3 is received. FIGS. 3 and 4 show the guide system and the window lifter in part or in sections.

The window lifter, designated as FH, of the adjustment device 1 has a first and a parallel second guide rail 6, on each of which a driver 7 with a rail sliding function in the longitudinal direction of the rail L is guided along an adjustment travel W, which is essentially oriented in the Z direction (FIG. 2). The driver 7 with the rail slider function can also be used as a rail slider with a driving function for the window pane 3. The coupling of the driver 7 to the window pane 3 is done here via one pane adapter 8 each. The respective guide rail 3 is mounted on the door frame (door shell) 2.

The window lifter FH of the adjustment device 1 also has an electromotive drive (adjustment or cable drive) 9. This has an unspecified electric motor with a coupled gearbox, in particular a worm gearbox, and is coupled to a cable drum in an unspecified manner. A traction cable 11, which is connected to the drivers 7 and is guided by deflection elements 10 (FIG. 4) on the rail end, is wound onto this drum as a loop, so that when the window lifter is in operation, one end of the cable is unwound from the cable drum and the other end of the cable is wound onto the cable drum. This adjusts the window pane 3, which is connected to the drivers 7, in order to move it, in the assembled state, along the adjustment travel W between a closed position and an open position.

In FIGS. 1 and 2, the drivers 7 for the functionalized window pane 3 are shown in an upper and in a lower, as well as in a middle position, along the adjustment travel W of the respective guide rail 6. The window lifter FH, which is designed as a so-called cable window lifter and has two strands in the example, has as essential components the guide rails 6 and the drivers 7 guided thereon with a sliding movement, as well as the adjustment travel 9 and the traction cable 11. In the example, this is designed as a Bowden cable.

The functionalized window pane 3 can be switched or controlled electrically. For this purpose, it has an electrical contact, directly or via a pane adapter 12, as a connection area 13. In this area, a plug contact (contact plug, contact element) 14 is electrically contacted. The plug contact 14 is connected to the cable 5. The flexible (elastic) component 4 is effective in the manner of a drag chain and is preferably designed as a corrugated pipe.

The cable 5 is received within the flexible component 4 of at least part of its length, i.e., in sections. In this context, cables are understood to be a plurality of conductors, in particular those enclosed by a cable or an insulating sheath, which serve to conduct current to and/or to control the functionalized window pane 3. The flexible component 4 can be made of plastic. The flexible, i.e., elastic, in particular elastically flexible, component 4 preferably completely encloses the corresponding cable or conductor section. The cross-sectional surface of the component 4 is expediently round, e.g., circular, but can also be angular, e.g., rectangular.

The corrugated pipe 4, as a flexible component in which the cable 5 is routed and by means of which the cable 5 is protected, is held in place by its tube end 15, facing away from the plug contact 14, on the door shell (door frame) 2. There, the cable 5 is connected, contacted, and/or coupled with a power source and/or a control device (controller, electronics). Preferably additionally, retaining clamps 16 on the shell or frame side are provided for the sectional or partial support of the corrugated pipe 4 and the cable 5 guided therein (FIG. 2).

As can be seen comparatively clearly, especially in connection with FIGS. 3 and 4, the guide system FS has a guide rail, which is arranged separately from the window lifter FH as a guide element 17, and a sliding element 18 guided along it. On the latter, the flexible component designed as a corrugated pipe 4 is held in place by its end, in which the cable 5 is in turn securely received or guided. The sliding element 18 is coupled to the functionalized window pane 3 in the area of the pane adapter 12 or the contact point 13 there. The sliding element 18 is therefore guided on the rail-like guide element 17, which is separated from the window lifter FH, along the adjustment travel W, when the window lifter FH is in operation.

The coupling of the sliding element 18 takes place exclusively via the functionalized window pane 3. The flexible component 4 is held in place on the one hand on the sliding element 18 of the guide system FS, and on the other hand is fixed to the door module or door shell 2. The rail-like guide element 17 for the sliding element 18 of the guide system FS is disposed parallel to the guide rails 6 of the window lifter FH and held in place on the door shell 2. The guide system FS has as its essential components the rail-like guide element 17 and the sliding element 18 guided by sliding movability, as well as the flexible component 4 for the cable 5, which is designed as a corrugated pipe.

The rail-like guide element 17 of the guide system FS has a guide area 19 running in the longitudinal rail direction L in the form of a longitudinal groove or channel (FIG. 4). The corrugated pipe 4 is guided in this when the sliding element 18 is moved from the upper position shown in FIGS. 1 to 4 to a middle or lower position shown in FIGS. 1 and 2.

As can be seen comparatively clearly from FIGS. 3 and 4, the sliding element 18 of the guide system FS is coupled to the functionalized window pane 3 or to the pane adapter 12 connected to it via a flexible connecting element 20. The flexible connecting element 20 is strip-like or band-like. The connecting element 20 is hinged to the functionalized window pane 3 or to the pane adapter 12. For this purpose, a hinge-like connection is established between the sliding element 18, which is guided by sliding movement on the rail-like guide element 17, and the pane adapter 12.

The hinge-like connection between the strip-like or band-like connecting element 20 and the pane adapter 12 is designed in the example as a pivot pin 21 on the connecting element 20 and corresponding articulated eyelets in the form of a hinge band 22 on the pane adapter 12. The hinge axis or rotational axis of the hinge-type connection 21, 22 is oriented in the X direction. In addition, the strip-like or band-like connecting element 20 can be flexed or torsionally moved in such a way that, for example, tolerances are compensated for and a necessary or sufficiently flexible connection of the sliding element 18 to the functionalized window pane/side window 3, in particular independent of the window lifter FH or its components is provided. Thus, the sliding element 18 of the guide system FS is only moved synchronously with the driver 7, or with each driver 7, of the window lifter FH as a result of the coupling via the window pane or side window 3. In this case, the cable 5 routed in the flexible component 4 is guided without collision or damage via the adjustment travel (adjustment stroke) W from the door shell 2 to the window pane or side window 3.

If the driver or each driver 7 is adjusted along the guide rail 6 of the window lifter FH in the longitudinal direction of the rail L, an adjustment of a movable component section of the corrugated pipe 4, which is movable in the rail-type guide element 17 relative to the shell or frame-fixed component section of the corrugated pipe 4, takes place. In this case, with an adjustment of the drivers 7 along the guide rails 6 of the window lifter FH, the movable component section passes the driver-fixed component section of the corrugated pipe 4 both in the direction of a closed position and in the direction of an open position of the functionalized window pane 3, at a distance oriented in a transverse direction to the longitudinal direction of the rail L—i.e., in the X-direction. In other words, in relation to the typical (usual) vehicle coordination system, the movable component section moving in the Z-direction passes through the driver-fixed component section of the corrugated pipe 4 at a distance extending in the X-direction from the guide element 17 of the guide system FS, which in turn is at a distance from the window lifter FH and in particular its guide rails 6.

The flexible or elastic component in the form of a corrugated pipe 4 is preferably guided in both the X and Y directions by means of the support or retaining contour 16. The flexible component 4 and the cable 5 guided in it lie stably in the XZ plane of the door shell (door frame) 2 and preferably cannot evade in the Y direction.

In summary, the invention relates to an adjustment device 1 for a motor vehicle, comprising a window lifter FH for adjusting a functionalized window pane 3 and a guide system FS for a cable 5, which serves to conduct current to and/or to control the functionalized window pane 3, wherein the guide system FS comprises a flexible component 4, which receives a cable 5 and a sliding element 18 that is coupled to the window pane 3, which is guided on rail-like guide element 17 that is separated from the window lifter FH.

The claimed invention is not limited to the examples described above. Rather, other variants of the invention can also be derived from it by the skilled person within the context of the disclosed claims, without departing from the subject-matter of the claimed invention. In particular, all the individual features described in context with the examples can also be combined in other ways within the framework of the apparent claims without departing from the subject-matter of the claimed invention. In addition, the described solution can not only be used in the specific use case described, but also in a similar design in other automotive applications, such as an adjustable sunroof in the vehicle.

The invention being thus described, it will be obvious that the same may be varied in many ways. Such variations are not to be regarded as a departure from the spirit and scope if the invention, and such all modifications as would be obvious to one skilled in the art to be included within the scope of the following claims.

What is claimed is:

1. An adjustment device for a functionalized window pane of a motor vehicle, the adjustment device comprising:
a window lifter to adjust the functionalized window pane along an adjustment travel;
a guide system for a cable that serves to conduct current to and/or to control the functionalized window pane and is connected or connectable to the functionalized window pane, the guide system having a flexible component to receive the cable; and
a sliding element coupled to the window pane, the sliding element being guided by a rail-like guide element that is separated from the window lifter along the adjustment travel.

2. The adjustment device according to claim 1, wherein the flexible component is designed and/or effective in the manner of a drag chain as a hollow tube or in the manner of a hollow tube or as a corrugated pipe, and/or wherein the flexible component is guided on and/or below the rail-like guide element of the guide system.

3. The adjustment device according to claim 1, wherein the flexible component encloses the cable at least in sections or at least substantially completely.

4. The adjustment device according to claim 1, wherein the flexible component is held in place in place by the sliding element of the guide system and fixedly by a body part of the motor vehicle on a door module or on a door shell.

5. The adjustment device according to claim 1, wherein the sliding element of the guide system is coupled or is adapted to be coupled via a flexible connecting element to the window pane or to a pane adapter connected to it.

6. The adjustment device according to claim 5, wherein the flexible connecting element is hinged to the window pane or to the pane adapter and/or to the sliding element.

7. The adjustment device according to claim 1, wherein the rail-like guide element of the guide system has a guide area for the component running in the longitudinal rail direction.

8. The adjustment device according to claim 1, wherein the window lifter has at least one guide rail with a driver for the window pane, which is guided by a sliding movement, and an adjustable drive or an electromotive drive that is connected to the driver via a traction cable, and wherein the rail-like guide element for the sliding element of the guide system is arranged parallel to the guide rail and is separated from the window lifter.

9. The adjustment device according to claim 1, wherein the sliding element of the guide system is coupled to the window lifter exclusively via the window pane.

10. A guide system for a cable that is connected or connectable to a functionalized window pane and serves to conduct current to and/or to control the functionalized window pane for the adjustment device according to claim 1, the guide system comprising:
a flexible component that receives the cable; and
a sliding element that is coupled to the window pane via a flexible connecting element, which is guided on a rail-like guide element and is connected to the flexible component.
